(19) United States
(12) Patent Application Publication
(10) Pub. No.: US 2025/0390706 A1
(43) Pub. Date: Dec. 25, 2025

(54) SYNTHETIC DATA GENERATION QUALITY USING IMMUTABLE TOKENS

(71) Applicant: INTERNATIONAL BUSINESS MACHINES CORPORATION, Armonk, NY (US)

(72) Inventors: Bhavna Agrawal, Armonk, NY (US); Anuradha Bhamidipaty, Yorktown Heights, NY (US); Jayshree Sanjayam, Bangalore (IN); Jonathan D. Dunne, Dungarvan (IE); Sarika Budhiraja, Westford, MA (US); Sattwati Kundu, Bangalore (IN)

(21) Appl. No.: 18/750,742

(22) Filed: Jun. 21, 2024

(51) Int. Cl. G06N 3/045; G06N 3/0475; G06N 3/08

(52) U.S. Cl. CPC G06N 3/045; G06N 3/0475; G06N 3/08

(57) ABSTRACT

Systems, methods, and computer program products are disclosed herein. A method comprises receiving a dataset comprising a plurality of text entities; determining one or more candidate immutable tokens from the dataset; determining one or more immutable tokens from the one or more candidate immutable tokens, based on a predetermined rule or a subject matter expert analysis; generating synthetic data, using a large language model, wherein the large language model is instructed to maintain the one or more immutable tokens; and filtering the generated synthetic data based on compliance with the one or more immutable tokens and the associated rules.

### TECHNICAL FIELD

Embodiments of the present disclosure are related to a system, method, and computer program product for synthetic data generation, and in particular, the use of immutable tokens in synthetic data generation.

### BACKGROUND OF THE DISCLOSURE

Generating high quality synthetic data is an important challenge in the use of large language model (LLM) techniques in the industrial domain, where the available data is very small, and the language is domain specific. One of the most common uses of LLMs in the industrial domain is multi-class classification (MCC). However, labeled datasets available for MCC are usually very small. Such empirical datasets are often enriched with synthetic data generated by LLM's to provide additional context for pre-training and fine-tuning.

Synthetic data generation is usually guided by instructions to allow for similar data generation. However, providing meaningful boundary conditions, yet enough flexibility, for the generation is a challenge. For example, the two sentences “Engine failed to start” and “Engine failed to stop” are very similar linguistically but belong to two different classes in common multi-class classification scenarios. This further illustrates an issue where the newly created data may not represent or match the empirical data. The interchangeable nature of certain words can lead to poor-quality synthetic data in data generation for natural language processing tasks. For example, “failed to start” and “failed to stop” may have similar structures, but substituting start with stop changes the meaning of the phrase entirely. This ambiguity reduces the effectiveness of downstream tasks such as classification.

Accordingly, there is a need for a systematic method for identifying boundary conditions by using linguistic immutable tokens, and then using the immutable tokens for synthetic data generation in a multi-classification problem.

### SUMMARY

Here, immutable tokens are determined within a set of data and used to generate synthetic datasets.

In an embodiment, a method for generating synthetic data, comprises receiving a dataset comprising a plurality of text entities; determining one or more candidate immutable tokens from the dataset; determining one or more immutable tokens from the one or more candidate immutable tokens, based on a predetermined rule or a subject matter expert analysis; generating synthetic data, using a large language model, wherein the large language model is instructed to maintain the one or more immutable tokens; and filtering the generated synthetic data based on compliance with the one or more immutable tokens.

In some embodiments, said filtering is performed using a large language model.

In some embodiments, the predetermined rule comprises identity, synonym, and/or antonym.

In some embodiments, the dataset comprises a plurality of classes.

In some embodiments, the method further comprises training a multi-class classification model, using the filtered synthetic data.

In some embodiments, the large language model is a generative pre-trained transformer model.

In some embodiments, the large language model is a masked language model.

In some embodiments, said determining of the one or more candidate immutable tokens comprise one or more of collocation, co-occurrence, repetitions, and/or part of speech analysis.

In some embodiments, determining the one or more candidate immutable tokens comprises identifying one or more tokens that maintain a meaning across one or more contexts in the dataset.

In some embodiments, a system comprises a datastore having stored therein a dataset comprising a plurality of text entities; a computing node comprising a computer readable storage medium having program instructions embodied therewith, the program instructions executable by a processor of the computing node to cause the processor to perform a method comprising: receiving a dataset comprising a plurality of text entities; determining one or more candidate immutable tokens from the dataset; determining one or more immutable tokens from the one or more candidate immutable tokens, based on a predetermined rule or a subject matter expert analysis; generating synthetic data, using a large language model, wherein the large language model is instructed to maintain the one or more immutable tokens; and filtering the generated synthetic data based on compliance with the one or more immutable tokens.

In some embodiments, said filtering is performed using a large language model.

In some embodiments, the predetermined rule comprises identity, synonym, and/or antonym.

In some embodiments, the dataset comprises a plurality of classes.

In some embodiments, the system further comprises training a multi-class classification model, using the filtered synthetic data.

In some embodiments, the large language model is a generative pre-trained transformer model.

In some embodiments, the large language model is a masked language model.

In some embodiments, determining of the one or more candidate immutable tokens comprise one or more of collocation, co-occurrence, repetitions, and/or part of speech analysis.

In some embodiments, determining the one or more candidate immutable tokens comprises identifying one or more tokens that maintain a meaning across one or more contexts in the dataset.

In alternative embodiments, a computer program product for generating a synthetic dataset comprises a computer readable storage medium having program instructions embodied therewith, the program instructions executable by a processor to cause the processor to perform a method comprising: receiving a dataset, the dataset comprising a plurality of classes; analyzing the dataset to determine one or more candidate immutable tokens; determining one or more immutable tokens from the one or more candidate immutable tokens, based on a predetermined rule or a subject matter expert analysis; generating synthetic data, using a generative large language model, based on the one or more determined immutable tokens; and filtering, using the generative large language model, the generated synthetic data based on one or more rules associated with the one or more immutable tokens.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1 is a process diagram for a method of generating synthetic data, in accordance with one or more embodiments of this disclosure.

FIG. 2 is a block diagram of methods to generate immutable tokens from a given dataset, in accordance with one or more embodiments of this disclosure.

FIG. 3 is a schematic illustrating a network architecture for generating synthetic data, in accordance with one or more embodiments of this disclosure.

FIG. 4 is a schematic illustrating the systems where one may use the synthetic data generation, in accordance with one or more embodiments of this disclosure.

FIG. 5 is an exemplary computing node.

### DETAILED DESCRIPTION

Reference will now be made in detail to the exemplary embodiments of the present disclosure, examples of which are illustrated in the accompanying drawings. Wherever possible, the same reference numbers will be used through-out the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as man-datory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

Embodiments of the present disclosure include Corpus linguistic analysis and token curation, providing a mechanism to determine and to use the linguistic immutable tokens for synthetic data generation for a multi-classification problem, and additional applications known to those in the art. In this context, “tokens” refer to words and phrases, as opposed to only parts of words.

The proposed approach tackles the problem of synthetic data generation by identifying immutable tokens that must adhere to the rules specified for such tokens (e.g. exact word/phrase, synonyms, antonyms, etc.). This includes conducting a priori analysis to identify tokens that maintain desired meaning across contexts and labeling them as immutable or protected; enabling specialized processing for immutable tokens using corresponding rules during synthetic data generation to enable desired effect (e.g. exact word/phrase, synonyms, antonyms, etc.); and performing post priori analysis of generated data to ensure the preservation of the meaning for immutable tokens. This process can be generalized across multiple text corpora, and multiple synthetic data generation techniques.

By leveraging these techniques, embodiments of the present disclosure enhance the quality and effectiveness of synthetic data generation, particularly in scenarios requiring precise linguistic preservation for accurate classification tasks.

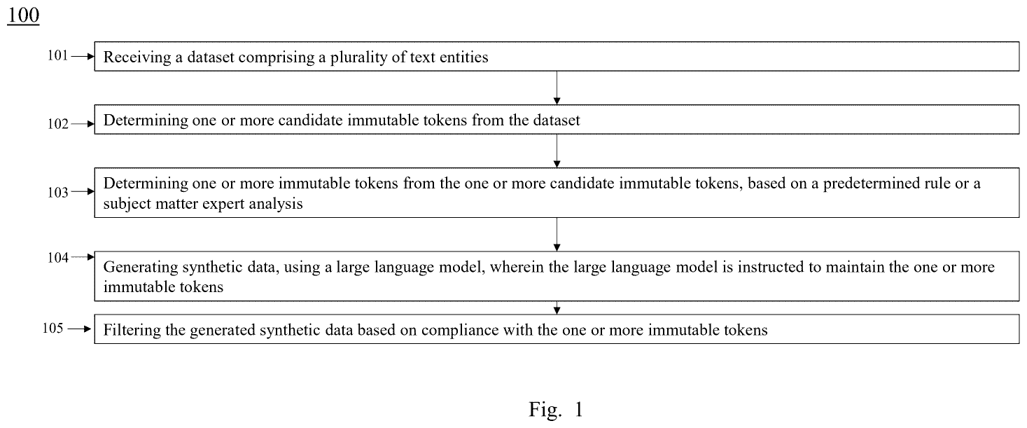

FIG. 1 is a process diagram illustrating a method 100 of synthetic data generation using immutable tokens. Method 100 (i.e., steps 101-105) may be performed automatically or in response to a request by a user. In step 101, the method may include receiving a dataset, the dataset comprising a plurality of classes. In step 102, the method may include analyzing the dataset to determine one or more candidate immutable tokens. The candidate immutable tokens may include results of collocation, co-occurrence, repetitions, or parts of speech analysis. The analysis may include linguistic analysis over a dataset of sentences, phrases, and/or words.

In step 103, the method may include determining one or more immutable tokens from the candidate immutable tokens. This determination may be based on a predetermined rule or subject matter expert analysis. In step 104, the method may include generating a synthetic dataset, using a generative large language model (LLM) based on the one or more determined immutable tokens. The synthetic dataset may contain immutable tokens.

Synthetic data generation may be done by, for example, using Masked Language Modeling (MLM) to generate data. For example, an input text may read “Engine failed to start.” The corresponding MLM inputs may include: “<mask> failed to start.”; “Engine <mask> to start.”; or “Engine failed to <mask>.” By using immutable tokens, a user can identify starting problems in the components, for example making “failed to start” an immutable token. Then, the MLM input becomes “<mask> failed to start.” Alternatively, “start” may be substituted with a synonym/synonym phrase, such as MLM inputs: “<mask> failed the starting sequence.”, or “<mask> failed to start.”

Similarly, generative methods may be given an instruction to include the immutable tokens or their synonyms in the generated output. For example, the prompt could be “generate more samples for the class ‘failed to function on demand’ where the concept of ‘failed to start’ is to be maintained in the generated samples.”

In step 105, the method may include using the LLM to filter the generated synthetic data based on one or more rules associated with the immutable tokens. The method 100 may further comprise training a multi-class classification model, with the filtered synthetic data for one or more downstream tasks.

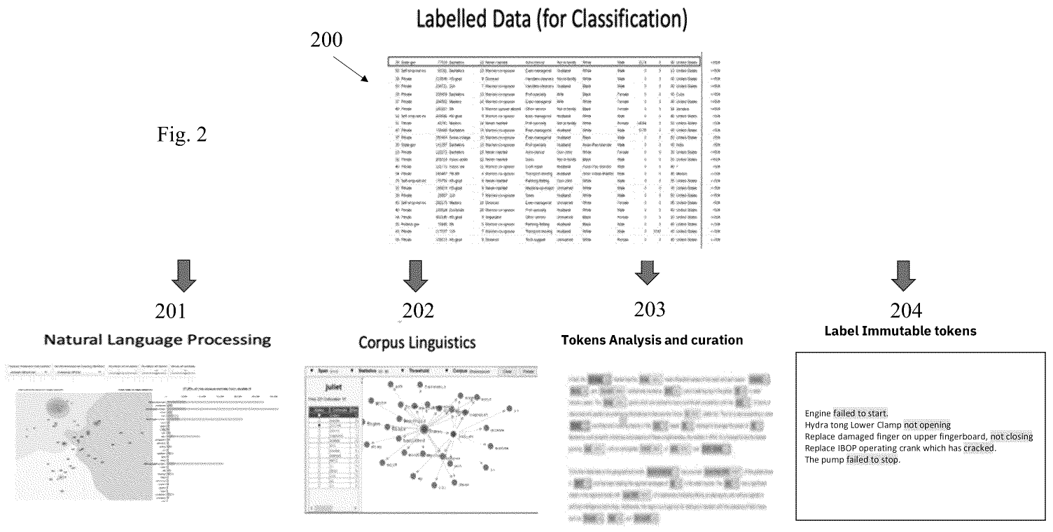

FIG. 2 illustrates a labelled dataset for classification. As described in steps 101-102, empirical labelled data is received and analyzed by the method 100. Analysis may include the use of existing linguistic models and token curation. Corpus linguistics may be used to determine key collocations (n-grams), co-occurrence, and repetitions in the labelled dataset; these are good candidates for being the immutable tokens. Corpus linguistics refers to computer-based empirical analyses (both quantitative and qualitative) of language use by employing large, electronically available collections of naturally occurring spoken and written texts, so-called corpora. Immutable token recognition can be used to determine the key entities within each label category for synthetic data generation in a multi-classification problem.

In FIG. 2, the labelled data 200 may be analyzed using natural language processing 201. Alternatively, analysis may be run using corpus linguistics 202, token analysis and curation 203, or by labelling immutable tokens 204, according to predetermined rules and conditions. Predetermined rules may be set by subject matter experts.

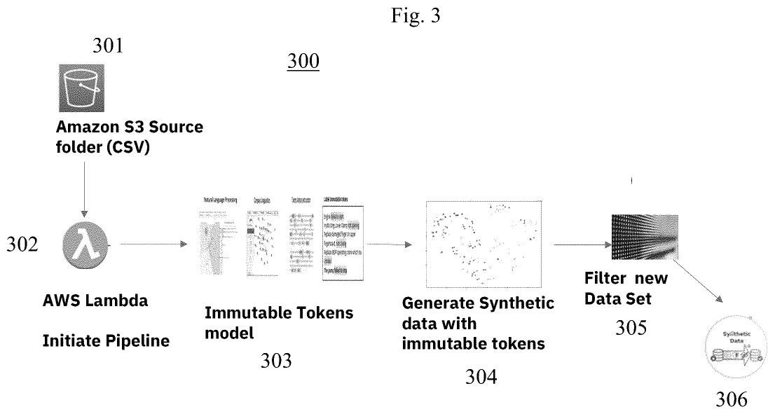

FIG. 3 is an illustration of an exemplary architecture and model 300 for generating synthetic data. The model 300 is utilized to identify immutable tokens essential for efficient synthetic data generation, guiding the provided instruction to an LLM for data generation. The diagram illustrates how an existing data and artificial intelligence (AI) pipeline can use embodiments of the present disclosure. At step 301, data is ingested as an exemplary from Amazon S3 Source folder (CSV). In step 302, the data is added to a data pipeline and passed to the immutable tokens model. This step may occur via an Amazon Lambda, where the pipeline may be initiated. In step 303, an immutable token model component determines the immutable tokens within each dataset class. In step 304, synthetic data is generated using the immutable tokens, and associated rules (e.g. synonyms, antonyms etc.) using various LLM techniques (including Generative LLM). In step 305, the new data set is filtered to ensure that the immutable token concepts are not violated (conceivably with another LLM). In step 306, the new dataset is used for other downstream tasks like multiclass classification.

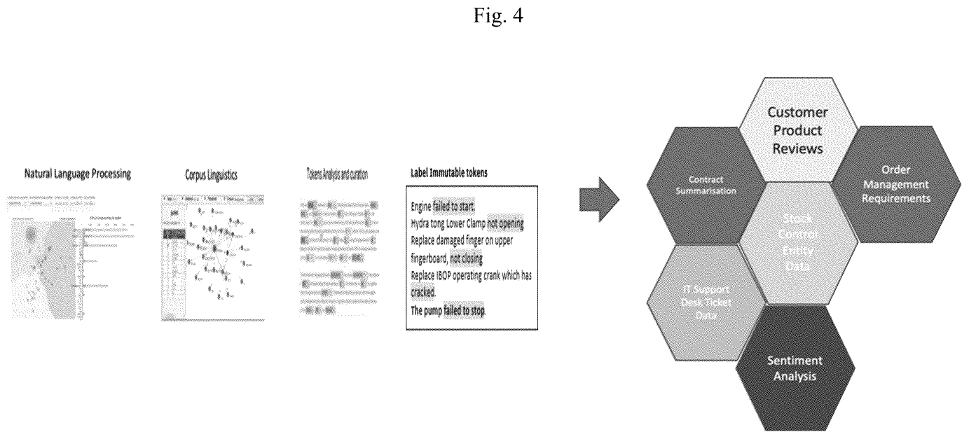

Due to the general approach to the technique in some embodiments of the present disclosure, this technique can be generalized across multiple text corpora and domains using the same technique, and across multiple synthetic data generation techniques. Some exemplary downstream uses are shown in FIG. 4, and include customer product reviews, order management requirements, stock control entity data, sentiment analysis, IT support desk ticket data, and/or contract summarization.

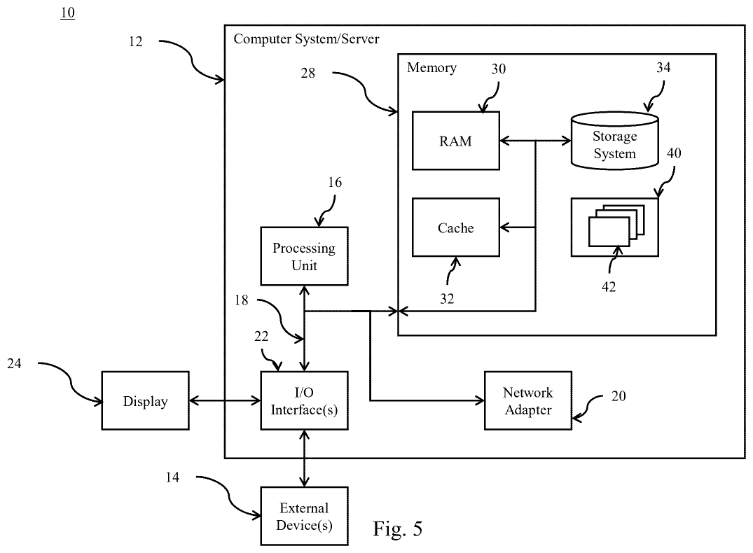

Referring now to FIG. 5, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for generating synthetic data, comprising:
receiving a dataset comprising a plurality of text entities;
determining one or more candidate immutable tokens from the dataset;
determining one or more immutable tokens from the one or more candidate immutable tokens, based on a predetermined rule or a subject matter expert analysis;
generating synthetic data, using a large language model, wherein the large language model is instructed to maintain the one or more immutable tokens; and
filtering the generated synthetic data based on compliance with the one or more immutable tokens.

2. The method of claim 1, wherein said filtering is performed using a large language model.

3. The method of claim 1, wherein the predetermined rule comprises identity, synonym, and/or antonym.

4. The method of claim 1, wherein the dataset comprises a plurality of classes.

5. The method of claim 4, further comprising:
training a multi-class classification model, using the filtered synthetic data.

6. The method of claim 1, wherein the large language model is a generative pre-trained transformer model.

7. The method of claim 1, wherein the large language model is a masked language model.

8. The method of claim 1, wherein said determining of the one or more candidate immutable tokens comprise one or more of collocation, co-occurrence, repetitions, and/or part of speech analysis.

9. The method of claim 1, wherein determining the one or more candidate immutable tokens comprises identifying one or more tokens that maintain a meaning across one or more contexts in the dataset.

10. The method of claim 1, wherein determining the one or more candidate immutable tokens comprises linguistic analysis.

11. The method of claim 1, wherein the one or more candidate immutable tokens include at least one full word and/or phrase.

12. A system comprising:
a datastore having stored therein a dataset comprising a plurality of text entities;
a computing node comprising a computer readable storage medium having program instructions embodied therewith, the program instructions executable by a processor of the computing node to cause the processor to perform a method comprising:
receiving a dataset comprising a plurality of text entities;
determining one or more candidate immutable tokens from the dataset;
determining one or more immutable tokens from the one or more candidate immutable tokens, based on a predetermined rule or a subject matter expert analysis;
generating synthetic data, using a large language model, wherein the large language model is instructed to maintain the one or more immutable tokens; and
filtering the generated synthetic data based on compliance with the one or more immutable tokens.

13. The system of claim 12, wherein said filtering is performed using a large language model.

14. The system of claim 13, wherein the predetermined rule comprises identity, synonym, and/or antonym.

15. The system of claim 13, wherein the dataset comprises a plurality of classes.

16. The system of claim 15, further comprising:
training a multi-class classification model, using the filtered synthetic data.

17. The system of claim 12, wherein the large language model is a generative pre-trained transformer model.

18. The system of claim 12, wherein the large language model is a masked language model.

19. The system of claim 12, wherein said determining of the one or more candidate immutable tokens comprise one or more of collocation, co-occurrence, repetitions, and/or part of speech analysis.

20. A computer program product for generating a synthetic dataset, the computer program product comprising a computer readable storage medium having program instructions embodied therewith, the program instructions executable by a processor to cause the processor to perform a method comprising:
receiving a dataset, the dataset comprising a plurality of classes;
analyzing the dataset to determine one or more candidate immutable tokens;
determining one or more immutable tokens from the one or more candidate immutable tokens, based on a predetermined rule or a subject matter expert analysis;
generating synthetic data, using a generative large language model, based on the one or more determined immutable tokens; and
filtering, using the generative large language model, the generated synthetic data based on one or more rules associated with the one or more immutable tokens.
